(19) United States
(12) Patent Application Publication
(10) Pub. No.: US 2007/0067714 A1
(43) Pub. Date: Mar. 22, 2007

(54) Modularized web page editing system and method thereof

(76) Inventor: Shui-Shun Lin, Taichung City (TW)

Correspondence Address: BIRCH STEWART KOLASCH & BIRCH, PO BOX 747, FALLS CHURCH, VA, 22040-0747, US

(21) Appl. No.: 11/227,131

(22) Filed: Sep. 16, 2005

(51) Int. Cl. G06F 17/00

(52) U.S. Cl. 715/513; 715/530

(57) ABSTRACT

The present invention discloses a modularized web page editing system and a method thereof, wherein via the Internet, the user utilizes solely a browser to link the system of the present invention; via a multi-template form module, the user can easily upload objects and contents needed by a web page to reassemble contents of the web page; the form module further comprises a date selection item for defining the self-triggered issue and close dates of a web page; and the system can directly update the database and can instantly retrieve contents of a web page so that the user can have a real-time monitoring for the web page.

### FIELD OF THE INVENTION

The present invention relates to a modularized web page editing system and a method thereof, particularly to a system and a method, which provides auxiliary templates, check box forms and text box forms to enable a web page to be easily edited, managed and dynamically updated.

### BACKGROUND OF THE INVENTION

Generally speaking, a web page is edited by the personnel having specialized knowledge in a single separate computer and with a special application software, and then, the web page is uploaded to the server providing web page service and executed in an appropriate directory path; thereby, a web page is updated or installed.

However, owing to the complicated editing and upload procedures, the user is beset by and wastes much time on such an editing way. Further, such an editing way needs much specialized knowledge, and for a simple web page manager, who has no appreciable specialized computer-related knowledge, it is too high a threshold and will hinder the editing or update of a web page. For example, it is very hard for a general user to install program codes into a web page for updating the issue or close function of the web page.

Furthermore, in such an editing way, web page editing and web page execution are separately performed; therefore, the user cannot preview the execution result of the web page being edited, and there is usually a difference between the execution result and that anticipated in web page editing, and thus, the review and editing works for a web page may be repeated many times, which will obviously degrade the editing efficiency of a web page.

At present, there is a professional application software for web page editing in the market, which intend to simplify web page editing procedures, reduce web page editing time, and enable the user to edit a web page easily by providing web page templates. However, they cannot yet solve the problem that web page editing and web page execution are separately performed. Further, the web page templates thereof are fixed, and thus, the user's originality for a web page is appreciably confined, which cannot satisfy the demand for a diversified and personalized web page.

Confronting the persistently progressive software and hardware technologies, it is an active subject of the network application suppliers to make the best of the characteristics of the Internet and the related software and hardware technologies thereof to propose a web page editing technology, which simplifies web page editing, reduces web page editing time, and enables the user to edit a web page easily without too much specialized knowledge and to spare more spirit on the contents of the web page.

### SUMMARY OF THE INVENTION

The primary objective of the present invention is to provide a modularized web page editing system and a method thereof, wherein the user can easily edit a web page via selecting check boxes and simply filling text boxes in forms, and can set or modify contents of a web page by himself via diversified auxiliary web page templates, so that a web page editing is simplified, the editing time is saved, and the editing efficiency is promoted.

Another objective of the present invention is to provide a modularized web page editing system and a method thereof, wherein the user can directly update the database and can instantly retrieve contents of a web page so that the user can have a real-time monitoring for the web page, i.e. what you see is what you get.

To achieve the abovementioned objectives, the modularized web page editing system of the present invention comprises a form module, a web page template and function module, an editing module, a retrieve and storage module, and a database.

And, the modularized web page editing method of the present invention comprises the following steps: logging in to access a form-managing web page; selecting a web page template and web page functions for a web page in a web page template and function module from a form, and then denominating and storing the web page; selecting editing blocks for editing the web page from the web page template; presenting editing forms of the editing blocks, and undertaking editing operation of selecting and uploading objects and contents; lastly, an editing module's receiving and processing the contents of the forms, and then storing the web page to a database.

### BRIEF DESCRIPTION OF THE DRAWINGS

FIG. 1 is a diagram showing the architecture of the modularized web page editing system of the present invention.

FIG. 2 is a flowchart of the modularized web page editing method of the present invention.

FIG. 3 is a schematic diagram showing the editing operations according to the modularized web page editing system and the method thereof of the present invention.

FIG. 4 is a schematic diagram showing the editing operation of setting the templates according to the present invention.

FIG. 5 is a schematic diagram showing the editing operation in the editing blocks according to the present invention.

FIG. 6 is a schematic diagram showing the editing operation of the web page contents according to the present invention.

### DETAILED DESCRIPTION OF THE PREFERRED EMBODIMENTS

The technical contents and detailed description of the present invention is to be stated below in cooperation with the attached drawings.

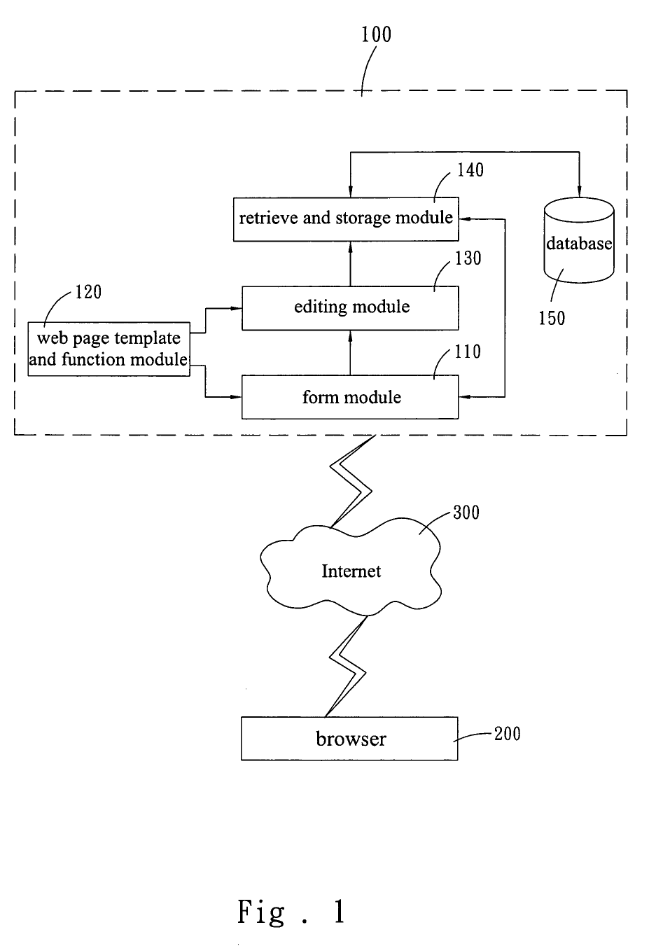

Refer to FIG. 1 a diagram of the system architecture of the present invention. The present invention provides a web page editing system having auxiliary web page templates and a method thereof. Via the Internet 300, the user utilizes a browser 200 to link the modularized web page editing system 100 of the present invention. The modularized web page editing system 100 of the present invention is described as follows.

A form module 110 provides selection forms for the browser 200. By the selection forms, the user can select and upload objects and contents of a new web page including contents and setting values stored in a database 150, and a web page template and functions. A corresponding content is back loaded according to acquired contents and a new web page is edited and created. The form module 110 further comprises a date selection item for defining the self-triggered issue and close date of the new web page.

A web page template and function module 120 provides a template configuration and functions for editing the web page, wherein each template provided by the web page template and function module 120 comprises multiple editing blocks. By the selection forms provided by the form module 110, the user can modify the contents by determining setting values for each attribute to create a web page the user needs, which includes adding, deleting, modifying, and moving blocks, and defining the self-triggered issue and close date of the web page. The web page template and function module 120 also has the function of creating the new web page template and storing it for future use. A layer technology is used to add, delete, modify and move blocks inside the editing blocks. The user can also use the form-type editing utility provided by the form module 110 to modify the contents and determine the setting values to create a revised block the user needs.

An editing module 130 edits corresponding program codes according to the form-type editing contents provided by the form module 110 including loading the linkage and function programs of the web page template and function module 120, and after the abovementioned processing, creating contents of the new web page, which can be accepted by the application program of a network server.

A retrieve and storage module 140 retrieves and stores the web page contents edited and processed by the editing module 130, and sends the web page contents inside a database 150, which has been normalized well, to the form module 110 so that the dynamically processed web page contents can be directly sent from the form back to the browser 200 in the user end for the user's review and subsequent editing.

A database 150 stores all web page-related data including various types of elements, such as texts, pictures, animations, movies, voice, forms, hyperlinks, etc.

The modularized web page editing system 100 of the present invention uses a login procedure of entering a username and a password to identify the user's credentials. Only after passing through the login procedure, the user can access the modularized web page editing system 100 to undertake an authorized web page editing.

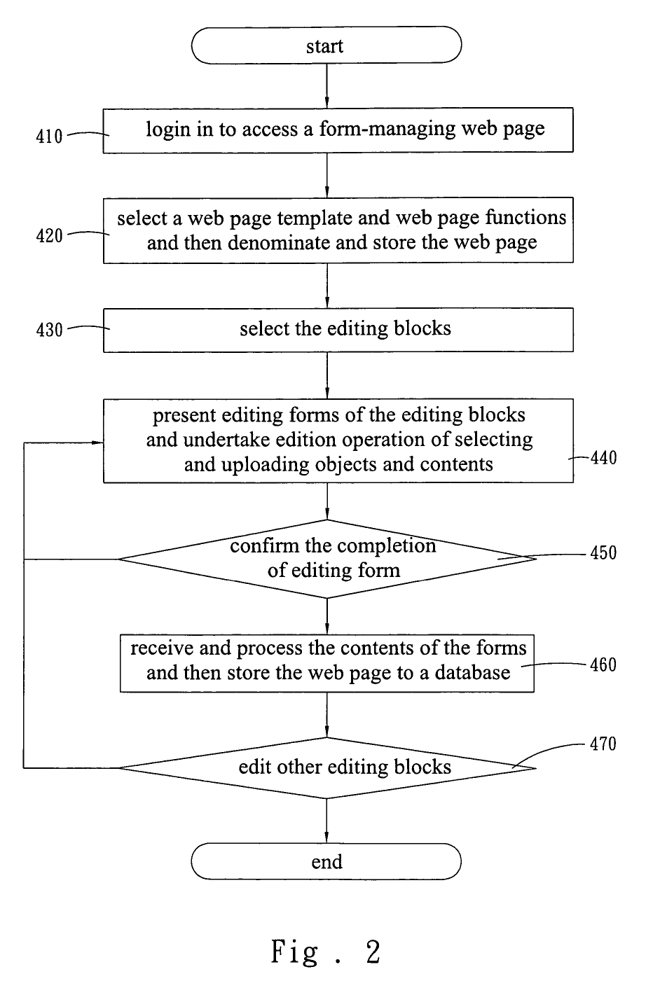

Refer to FIG. 2, a flowchart of the operational method of the modularized web page editing system 100. The steps comprised by the method of the present invention are described below.

Firstly, the user, usually a webmaster, undertakes a login procedure via the browser 200, wherein the username and password of the user are identified, to build a linkage between the browser 200 and the modularized web page editing system 100 so that the user can access the modularized web page editing system 100 (Step 410).

Next, the user utilizes the web page templates and functions sent from the web page template and function module 120 to undertake web page editing in the forms provided by the form module 110 (Step 420), and utilizes the check box form and the text box form to upload the objects and contents the web page needs, and denominates and stores the web page. Each template has multiple editing blocks, and the user can also utilize the selection form provided by the form module 110 to edit the blocks. If the user is not satisfied with the block configuration of the selected web page template, he or she can modify the contents and set the setting values by himself to create the web page contents meeting his demand including adding, deleting, modifying, moving blocks etc. the user can further utilize the function module to design a new web page, and store it for future use. The user can also utilize the date control module to define the self-triggered issue and close dates of the web page.

Next, the user selects the editing blocks (Step 430), and the system will present the editing forms for editing the blocks on the browser 200 in the user end. Then, the user can utilize the check boxes and text boxes of the editing forms to upload the objects and contents the web page needs to edit and set the contents of the selected editable blocks (Step 440), wherein a layer technology is used to add, delete, modify, and move the blocks, and the user can also utilize the form-type editing tools, which is provided by the form module 110 and has check boxes and text boxes, to edit the web page contents easily via selecting the check boxes and filling the text boxes so that the user can modify the contents and determine the setting values by himself to create the block contents he or she needs. The user can configure the contents of the editing blocks to be presented, such as texts, pictures, animations, movies, voice, forms etc, in many ways, and clicks on a “Preview Document” button to download the web page to the browser 200 in the user end, and thus, the user can obtain the editing result in real-time.

Then, the system will determine whether the user has clicked on the “Store Document” button on the editing form and confirmed the completion of editing (Step 450). If the editing has not been completed yet, the process will stays in Step 440 to enable the user to keep on editing. If the completion of editing is confirmed, the system will transfer the contents of the editing forms to the editing module 130 for executing a dynamic editing processing on the form contents, i.e. according to the user's form, utilizing corresponding program codes to execute creation, modification, or deletion action on the web page. A new web page will be instantly created and stored (Step 460), and the user can obtain the editing result in real-time.

The system will determine whether the user continues to edit other editing blocks (Step 470). If yes, the process returns to Step 440 to enable the user to undertake the editing operations of other editing forms. If no, the editing process of the web page ends.

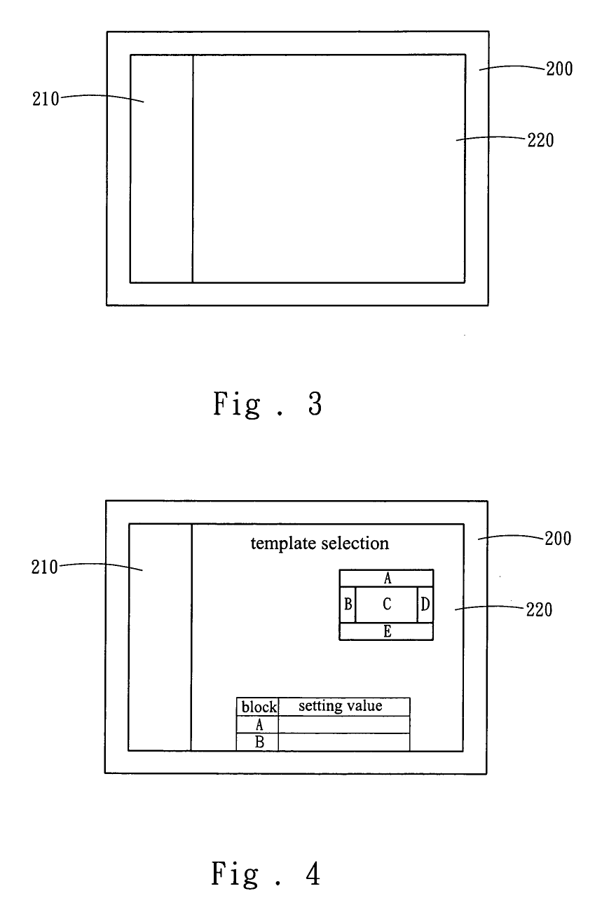

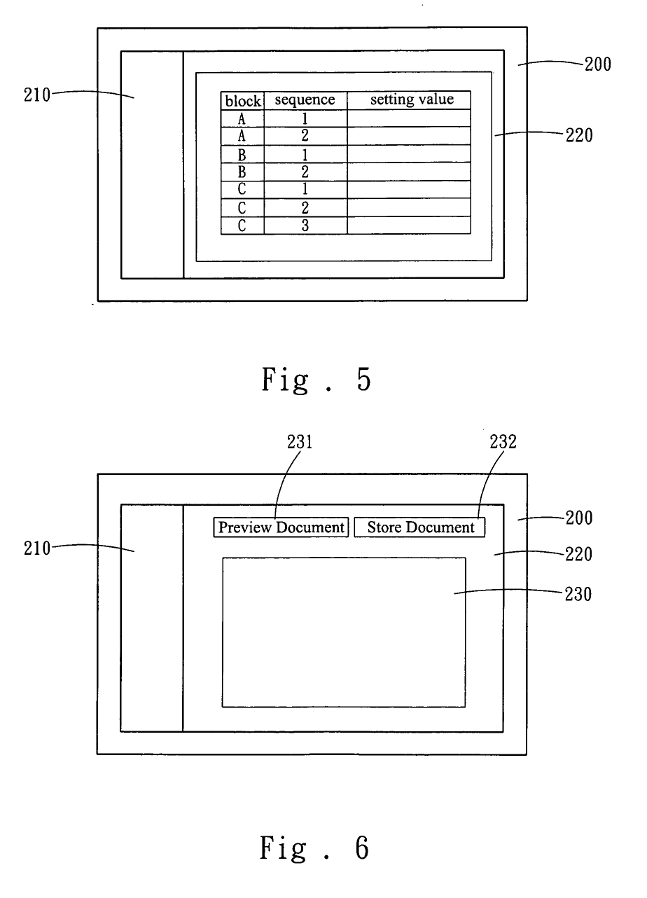

The embodiments in FIG. 3, FIG. 4, FIG. 5, and FIG. 6 are to be used to further exemplify the present invention. In FIG. 3, the user selects a template management function from a management selection menu 210, and the templates of the web page template and function module 120 are formatted into a list in an operational block 220. After the user has selected or configured the template he or she needs, the operational block 220 presents the configuration layout and the setting value list of web page editing blocks A, B, C, D, E to show the objects being edited by the user, as shown in FIG. 4.

Then, the user undertakes the editing operations of those editing blocks A, B, C, D, E, as shown in FIG. 5, and the operational block 220 shifts to present the settings and contents of each editing block, such as a bulletin board, a forum, a picture, breaking news, membership management, merchandise presentation and withdrawal, voting design etc, and the sequence of the contents of each editing block. At this time, the form module 110 also provides the user with selection forms, and the user can use the selection forms to modify the contents and set the setting values by himself to create the revised blocks having the contents configuration he or she needs, such as various configurations of texts, pictures, animations, movies, voice, forms, hyperlinks, etc.

Then, as shown in FIG. 6, in contents blocks 230 of each editing block, the user also uses selection forms to select related setting values of the editing block, such as the self-triggered issue and close dates of the web page, object-related data, and related links. The user can also use a simple text block to add the contents that the user intends to show or the more powerful HTML/JAVA web page language in order to create the contents configuration the user needs including texts, pictures, animations, movies, voice, forms etc. The user can click on a “Preview Document” button 231 to download the web page being edited to the browser 200 in the user end, and the user can instantly review the editing result. Therefore, the web page editing implemented with the modularized web page editing system and the method thereof of the present invention is a WYSWYG (What You See Is What You Get) editing process in fact.

The user can also click on a “Store Document” button 232 to confirm the completion of the editing operations in the editing forms, and the system will transfer the contents of the forms to the editing module 130, and the editing module 130 will execute a dynamic editing processing to instantly create contents of a new web page and then store it.

The modularized web page editing system and the method thereof of the present invention enable the user to edit a web page via only a browser. Via the form-type configuration and setting of the web pages templates and the editing blocks provided by the present invention, the user can arbitrarily add, delete, modify, move the editing blocks of the web page templates to create a web page he or she needs without having too much specialized knowledge of computer, and without spending time on the complicated editing procedures of the web page contents. Via the form-type management, the user can arrange the self-triggered issue and close date of a web page so that the web page editing can be simplified, and the time thereof can be reduced, and the efficiency thereof can be promoted.

Those described above are only the preferred embodiments of the present invention and not intended to limit the scope of the present invention. Any equivalent modification and variation according to the spirit of the present invention is to be included within the scope of the claims of the present invention.

What is claimed is:

1. A modularized web page editing system, which the user utilizes a browser to link via a network and provides modularized web pages for editing a web page, comprising:
a form module, providing selection forms for selecting and uploading objects and contents needs by said web page;
a web page template and function module, providing a template configuration and function modules for editing said web page;
an editing module, editing corresponding program codes according to the contents sent out by said form module, and creating a processed contents of said web page;
a retrieve and storage module, retrieving and storing the contents of said web page edited by the user; and
a database, storing all web page-related data of the user.

2. The modularized web page editing system according to claim 1, wherein a username and a password are used in the user identification step of the login procedure.

3. The modularized web page editing system according to claim 1, wherein web page templates of said web page template and function module can be further formed into new web page templates via said function modules.

4. The modularized web page editing system according to claim 3, wherein said web page template further comprises multiple editing blocks.

5. The modularized web page editing system according to claim 4, wherein a layer technology is used to add, delete, modify, and move said editing blocks of said web page template.

6. The modularized web page editing system according to claim 1, wherein via said retrieve and storage module, said form module calls said web page template for editing the contents of said web page template and said editing blocks thereof.

7. The modularized web page editing system according to claim 1, wherein said form module further comprises a date selection item for defining the self-triggered issue and close dates of said web page.

8. The modularized web page editing system according to claim 1, wherein according to said form module, said editing module utilizes corresponding program codes to execute creation, modification, and deletion action on said web page.

9. A modularized web page editing method, wherein the user links a browser to a web page editing system via a network, and modularized web pages are provided for editing a web page, comprising the following steps:
logging in to access a web page managing forms;
via forms, the user's selecting a web page template and functions needed by a web page from a web page template and function module, and denominating said web page, and then storing said web page;
selecting editing blocks, which are intended to be edited, from said web page template;
presenting editing forms of said editing blocks, and undertaking editing operations of selecting and uploading objects and contents; and
an editing module's receiving and editing the contents of said forms, and storing the contents of said web page to a database.

10. The modularized web page editing method according to claim 9, wherein a username and a password are used for the user identification in said logging in.

11. The modularized web page editing method according to claim 9, wherein web page templates of said web page template and function module can be further formed into new web page templates via said function module.

12. The modularized web page editing method according to claim 11, wherein said web page template further comprises multiple editing blocks.

13. The modularized web page editing method according to claim 12, wherein a layer technology is used to add, delete, modify, and move said editing blocks of said web page template.

14. The modularized web page editing method according to claim 9, wherein via a retrieve and storage module, said form module calls said web page template for editing the contents of said web page template and said editing blocks thereof.

15. The modularized web page editing method according to claim 9, wherein said form module further comprises a date selection item for defining the self-triggered issue and close dates of said web page.

16. The modularized web page editing method according to claim 9, wherein according to a form module, said editing module utilizes corresponding program codes to execute creation, modification, and deletion action on said web page.
